(19) United States
(12) Patent Application Publication
(10) Pub. No.: US 2021/0371582 A1
(43) Pub. Date: Dec. 2, 2021

(54) Polyester Composition with Improved Dyeing Properties

(71) Applicant: Parkdale Incorporated, Gastonia, NC (US)

(72) Inventor: Robert A. Usher, Charlotte, NC (US)

(73) Assignee: Parkdale Incorporated, Gastonia, NC (US)

(21) Appl. No.: 17/216,752

(22) Filed: Mar. 30, 2021

Related U.S. Application Data
(60) Provisional application No. 62/990,191, filed on Mar. 16, 2020.

(51) Int. Cl. C08G 63/672; D06P 3/52; D06P 3/54; D06P 3/82; D01F 6/84; D02G 3/04

(52) U.S. Cl. CPC C08G 63/672; D06P 3/528; D06P 3/54; D06P 1/16; D01F 6/84; D02G 3/04; D06P 3/8276

(57) ABSTRACT

A composition with advantages for textile fibers is disclosed. The composition is a melt of polyester precursors selected from the group consisting of terephthalic acid, dimethyl terephthalate, ethylene glycol, sebacic acid in an amount sufficient to give filaments and fibers made from the melt a dye receptivity similar to cotton at atmospheric pressure; pentaerythritol in an amount sufficient to give pill resistance to yarns blended of cotton with fibers made from the melt, and polyethylene glycol in an amount sufficient to give the melt the elasticity necessary to produce extruded filament from the melt. In an exemplary embodiment, the copolymer melt includes between about 4 and 6 percent sebacic acid, between about 500 and 800 ppm pentaerythritol, and between about 3.5 and 3.9 percent polyethylene glycol, with less than 2 percent DEG, at an intrinsic viscosity of between about 0.640 and 0.690 dl/g, and at a temperature of between about 268° C. and 271° C., with the proportional amounts being based on the amount of polymerized copolymer.

### RELATED APPLICATIONS

This application is related to Ser. No. 15/258,308 filed Sep. 7, 2016 (now U.S. Pat. No. 10,174,454); Ser. No. 15/258,338 filed Sep. 7, 2016 (now U.S. Pat. No. 10,351,995); Ser. No. 16/188,132 filed Sep. 9, 2016; and Ser. No. 16/190,772 filed Nov. 14, 2018; each entitled “Polyester Composition with Improved Dyeing Properties”

### BACKGROUND

The present invention relates to polyester copolymer compositions suitable for synthetic filaments and to fibers and fabrics that can be made from such compositions. In particular, the invention relates to compositions that will produce fibers that can be blended and dyed with cotton under conditions that are more typically favorable for cotton than for polyester.

The use of synthetic compositions to produce filaments, fibers, and then fabrics is well established. Accordingly, improvements in such entrenched compositions can be particularly advantageous. Such improvements are, of course, more valuable when they enhance desired characteristics of filaments, fibers, fabrics, and items—very often clothing—made from such compositions.

Working backwards, a garment is typically formed of a fabric that is either woven or knitted from yarns. In turn, yarns are formed from individual fibers joined together, most commonly using well-known and well-established spinning processes.

Natural fibers—the most common are cotton and wool—have characteristics that produce desired properties in yarns, fabrics, and garments. For example, wool has (among other advantages) excellent thermal properties and remains insulating when wet. Unless treated properly, however, wool can be abrasive and thus uncomfortable when in contact with skin for extended intervals. Cotton produces fabrics that are comfortable and breathable but can lose its thermal insulation properties when wet.

Further advantages of cotton, wool, and other natural fibers are generally well understood in the art.

In the same manner, synthetic fibers have some properties that are subjectively better then natural fibers, some of which can include (particularly in the case of polyester) strength, durability, and “memory.”

Accordingly, one of the goals in producing or designing or developing synthetic compositions for eventual use as fibers, yarns and fabrics is to take advantage of some of the favorable properties of synthetics, while matching as closely as possible—or in some cases improving upon—the desired properties of natural fibers (e.g., the thermal insulation of wool, but less abrasive; the comfort of cotton, but with better thermal properties when wet).

In the clothing industry, the ability to produce garments with desired colors is a fundamental goal. The nature of both natural and synthetic fibers and their underlying chemical compositions requires, however, that color be obtained by some type of dyeing process. Depending upon circumstances, fibers can be dyed as fiber, filament, yarn, fabric, or even as a garment. Furthermore, because in many cases consumers expect to be able to wash and dry garments in machines many times, an associated goal is to obtain garments that can withstand such repeated machine washing and drying while still maintaining most or all of the desired color. Related goals include light fastness (typically with respect to exposure to sunlight) and (using active wear as another example) color stability when exposed to perspiration.

Fundamentally, the relationship between the color of a garment and its lifetime will be based upon the chemical composition of the underlying fibers and the chemical composition of an appropriate dye composition. As is well understood in the art, a dye is technically defined as “a colorant that becomes molecularly dispersed at some point during application to a substrate and also exhibits some degree of permanence.” Tortora, FAIRCHILD'S DICTIONARY OF TEXTILES, Seventh Edition, 2009 Fairchild Publications.

Dye is typically categorized as either natural (e.g., from plants) or synthetic (e.g., typically developed from other compositions using principles and techniques of organic chemistry).

The dyeing characteristics of a fiber are based upon the composition from which the fiber is formed. The desired property is referred to as “dyeability,” which is defined as the “capacity of fibers to accept dyes.” (Tortora, supra).

In the manufacture of garments, it is also common to blend synthetic fibers with natural fibers in proportions that produce a finished garment with desired properties. For a number of reasons, blends of cotton and polyester have long been popular. Based on that, compositions and methods for producing dyed color in cotton-polyester blends has been and remains a desired outcome. The natures of the two different fibers, however, present practical problems. For example, cotton can be conveniently dyed with “reactive dyes” that can be successfully added to a cotton substrate at temperatures of about 65° C. (150° F.).

On the other hand, the properties of polyester (i.e., the polymer formed from the condensation esterification and then polymerization of terephthalic acid and ethylene glycol) require that polyester be dyed with “disperse dyes;” i.e., small particles of colorant suspended in water (Tortora, supra).

Coloring polyester conventionally with disperse dyes tends to require significantly higher temperatures; typically above 120° C. (250° F.) and frequently on the order of 130° C. (270° F.) or higher. In many cases, high pressure (i.e., above atmospheric pressure) is also required to successfully dye polyester, or to reach the temperatures required to dye the polyester (Tortora, supra).

As further comparative factors, cotton dyeing tends to be driven by the pH of the dye solution or composition (typically in a basic environment); while polyester dyeing tends to be driven by the temperature, and conventionally requires the addition and performance of supplementary chemicals commonly referred to as “carriers” or “leveling agents.” From the standpoint of economics, disperse dyes (sometimes referred to as “high energy” dyes because of the conditions required) are more expensive than reactive dyes, and sometimes by as much as a factor of 5·10 times on a comparative basis.

Because of the differences in the dyeing compositions and the dyeing conditions, it is conventional practice to dye cotton and polyester separately.

In some conventional methods, blended cotton-polyester fabric is dyed in two separate steps. In a first step, the fabric is dyed in a slightly acidic bath at a temperature of about 130° C. (270° F.) or higher (e.g., using a disperse dye) in order to get the polyester to accept the dye. The partially dyed fabric is then scoured or rinsed, and thereafter dyed in a cotton-appropriate dye (e.g., a direct or reactive dye) at a basic pH and at a temperature of about 65° C. (150° F.). Because many cotton dyestuffs will degrade at the polyester dying temperatures, the two steps cannot be combined.

As another factor that must be addressed, high dyeing temperatures tend to degrade the elasticity of stretch fibers such as spandex that are often included in cotton-polyester fabrics and garments. Some versions of spandex can withstand high dyeing temperatures (e.g. 130° C./270° F.), but are proportionately more expensive than versions that have essentially the same end-use properties, but that tend to degrade when dyed at such higher temperatures.

As yet another factor, perceived color (e.g., of a garment) is a combination of the interaction of light, the material the light illustrates, and the resulting perception of the human eye. In terms of textile dyeing, the color of the dye is based upon the functional groups in the dye molecules. Stated differently, different colors in textiles are a function of dye molecules with different compositions. Not all dye colors (i.e., the underlying molecules) perform, however, in the same manner with either natural or synthetic fibers, yarns, or garments. Thus a fiber, yarn, blend, or fabric may accept certain dye colors relatively straightforwardly while rejecting (to some greater or lesser extent) other dye colors under the same conditions.

Furthermore, additives are often used to control or adjust the properties of a polymer melt, and the features of such additives are likely to change either the dyeing characteristics or the spinning characteristics or both.

As another factor, synthetic fibers—and certainly including polyester—are typically manufactured by polymerizing the starting materials and thereafter extruding a melt of the polymer through small openings in a device referred to as a spinneret; a process referred to as “spinning ” Those experienced in synthetic and natural fibers will immediately recognize that the term “spinning” is used to refer to two entirely different processes. In one meaning (and since antiquity) spinning refers to the step of twisting individual fibers together and pulling them into a yarn. In the manufacture of synthetic fibers, the extrusion of filaments from a melt into solidified polymer filaments is also referred to as “spinning ” The difference is normally clear in context. Typically, the solidification of the extruded filaments is encouraged or advanced using a quenching step, in which a carefully controlled airflow is directed against the extruded filaments.

The properties required of a composition that can be melt and spun in this fashion, however, may be unrelated to, or disadvantageous in combination with, the properties that produce good dyeing characteristics. Composition characteristics that produce the proper viscosity for spinning may be entirely unrelated, and in some cases directly opposite to, those properties that produced good dyeing characteristics. Thus, designing or adjusting the composition of a polymer, copolymer or copolymer blend to improve the spinning properties may result in less desired or even unacceptable dyeing properties.

For example, in order to “spin” properly, a melted polymer must have a certain fluidity (viscosity) that permits the extrusion to produce coherent liquid filaments (i.e. that won't separate) at the spinneret while avoiding a viscosity that is too low (“watery”) to control the spinning process for its intended purpose. Because the viscosity of a polymer melt is proportional to temperature, the degree of polymerization, and to other polymer properties, the spinning temperature must be appropriate as well. Stated differently, the melted polymer must be able to perform within an appropriate range of spinning temperatures.

In the context of synthetic fibers and their manufacture, the term “melt viscosity” refers to the specific resistance of the melted polymer to deformation or flow under any given conditions. The term “intrinsic viscosity” is used to describe a characteristic that is directly proportional to the average molecular weight of a polymer. Intrinsic viscosity is calculated on the basis of the viscosity of a polymer solution (in a solvent) extrapolated to a zero concentration. Thus, the intrinsic viscosity is a characteristic that will affect the melt viscosity, but the melt viscosity is also related to other factors, particularly including the temperature of a melt.

As yet another factor, because synthetic fibers originate as a filament, they must be cut and textured (not necessarily in that order) to gain other properties that are desirable in a finished yarn, fabric, or garment. In most cases, the texturing step requires that the synthetic filament or fiber be mechanically or thermally formed into a shape other than a straight extruded filament. Accordingly, the need to texturize polyester adds another set of properties that must be accounted for and that may compete against the properties that enhance polymerization, spinning, or dyeing.

Thus, a need exists for polymer compositions that can produce a fiber that can—if desired—be dyed with cotton in successive steps in a single vessel.

### SUMMARY

In one aspect the invention is a copolymer composition with advantages for textile fibers. In this aspect, the invention is a melt of polyester precursors selected from the group consisting of terephthalic acid, dimethyl terephthalate, and ethylene glycol; sebacic acid in an amount sufficient to give filaments and fibers made from the melt a dye receptivity similar to cotton at atmospheric pressure; pentaerythritol in an amount sufficient to give pill resistance to yarns blended of cotton with fibers made from the melt; and polyethylene glycol in an amount sufficient to give the melt the elasticity necessary to produce extruded filament from the melt. In an exemplary embodiment, the copolymer melt includes between about 4 and 6 percent sebacic acid, between about 500 and 800 ppm pentaerythritol, and between about 3.5 and 3.9 percent polyethylene glycol to a copolymer melt with less than 2 percent DEG, at an intrinsic viscosity of between about 0.640 and 0.690 dl/g and at a temperature of between about 268° C. and 271° C., with the proportional amounts being based on the amount of polymerized copolymer.

In another aspect, the invention is a copolymer with advantages for textile fibers. In this aspect the invention includes polyester copolymer, between about 4 and 6 percent sebacic acid, between about 500 and 800 ppm pentaerythritol, and between about 3.5 and 3.9 percent polyethylene glycol, with less than 2 percent DEG, with the proportional amounts being based on the amount of polymerized copolymer.

In another aspect, the invention is a method of spinning a polyester copolymer filament. The method includes the steps of polymerizing terephthalic acid, ethylene glycol, between about 4 and 6 percent sebacic acid, between about 500 and 800 ppm pentaerythritol, and between about 3.5 and 3.9 percent polyethylene glycol to a copolymer melt with less than 2 percent DEG, at an intrinsic viscosity of between about 0.640 and 0.690 dl/g and at a temperature of between about 268° C. and 271° C., with the proportional amounts being based on the amount of polymerized copolymer.

In another aspect, the invention is a method of coloring yarn blended from cotton and textured polyester copolymer staple in which the yarn is between about 20 percent and 80 percent by weight cotton. The textured polyester staple in the blended yarn has a composition of between about 4 and 6 percent sebacic acid, between about 500 and 800 ppm pentaerythritol, and between about 3.5 and 3.9 percent polyethylene glycol, with less than 2 percent DEG, with the proportional amounts being based on the amount of polymerized copolymer. The dyeing step for the polyester (disperse dye) can be carried out at atmospheric pressure and a temperature below 212° F. (100° C.).

In another aspect, the invention is a blended yarn. The yarn contains between about 20 percent and 80 percent by weight cotton, and textured polyester copolymer staple as the remainder. The textured polyester staple has a composition of between about 4 and 6 percent sebacic acid, between about 500 and 800 ppm pentaerythritol, and between about 3.5 and 3.9 percent polyethylene glycol, with less than 2 percent DEG, with the proportional amounts being based on the amount of polymerized copolymer.

The foregoing and other objects and advantages of the invention and the manner in which the same are accomplished will become clearer based on the followed detailed description.

### DETAILED DESCRIPTION

As set forth herein, the goal of the invention is to produce a fiber that is based upon polyester (most commonly polyethylene terephthalate) that can be dyed with cotton in a single vessel. Commonly assigned Ser. No. 15/258,308 describes a successful option for meeting the goal of single vessel dyeing with cotton.

As well understood in the art, cotton is typically dyed with reactive or direct dyes at temperatures of about 150° F. (66° C.; i.e. well below the boiling point of water) and atmospheric pressure. Polyester is typically, and necessarily, dyed with disperse dyes which require much higher temperatures (above 250° F. in most cases) and thus also may require pressurized equipment (above atmospheric pressure conditions) in order for the dye dispersion to penetrate the polyester. Cotton dyeing tends to be most successful at higher (basic) pH, while the disperse dyes used with polyester typically require a lower (acidic) pH along with additives referred to as carriers or leveling agents (such as fatty acid derivatives) which function to help the dye migrate throughout the substrate material.

In the textile art, terms such as “texturing” and “crimping,” are used both broadly and specifically. In the broadest sense, texturing and crimping are used as synonyms to refer to steps in which synthetic filament, staple fiber, or yarn is mechanically treated, thermally treated, or both, to have a greater volume then the untreated filament, staple, or yarn. In a narrower sense, the term crimping is used to describe the production of a two dimensional saw tooth orientation in a filament, fiber or yarn, while the term texturing is used to refer to treatments that produce looping and curling. The meaning is generally clear in context. In the specification and claims, the word “texture” is used in a broad sense to include all possibilities for producing the desired effect in a filament, staple fiber, or yarn.

According to the invention, it has been unexpectedly determined that the presence of diethylene glycol in percentages above about 2% lead to problems dyeing cotton polyester blends with certain dye colors under cotton-favorable conditions.

Based on additional trial compositions and then dyeing and color fastness testing, the invention provides a polyester copolymer that will dye with cotton with much better results over a wider range of colors than previous compositions and attempts. The improved copolymer can be produced by incorporating sebacic acid in an amount of between about 4 and 6 percent sebacic acid, between about 500 and 800 ppm pentaerythritol, and between about 3.5 and 3.9 percent polyethylene glycol to a copolymer melt with less than 2 percent DEG, with the proportional amounts being based on the amount of polymerized copolymer.

The composition is a copolymer because some units are the esterification and polycondensation product of terephthalic acid and ethylene glycol, while others are (for example) the esterification and polycondensation product of sebacic acid and ethylene glycol. The linking of each base ester molecule starts in esterification and then is multiplied many times in polycondensation.

The relativity high level of pentaerythritol increases the reactivity of the polymerization reaction. Thus, the conventional expectation is that a lower temperature melt is required to moderate this reactivity. In the invention, however, the pentaerythritol and the increased reactivity are allowed to increase the intrinsic viscosity of the polymer and the overall viscosity of the melt.

Conventionally the intrinsic viscosity of polyester used for the filament and then staple fiber is kept at about 0.52-0.65 dl/g. A less viscous melt tends to be too “watery” and an overly viscous melt tends to separate during extrusion from the spinneret (spinning) In the invention, the intrinsic viscosity is allowed to significantly increase, and in particular to reach between about 0.640 and 0.690 dl/g. Given that conventional copolymers tend to run at lower intrinsic viscosities, the higher intrinsic viscosity of the invention is counterintuitive.

Conventionally, in order to get a lower intrinsic viscosity polymer to spin and quench properly, the spinning temperature is reduced. In contrast to this, the composition of the invention is allowed to spin at temperatures that are more conventional for polyester made from monomer (for example 280° -290° C. in the high polymerizer).

Thus, although the spinning temperature for a copolymer with 4.5 to 5.5 percent of polyethylene glycol would conventionally be lowered to about 280° C., in the invention the spinning is carried out at the same temperature as conventional polyester monomer; e.g., about 285-290° C.

The added pentaerythritol reduces the tenacity of the resulting filament, but in the invention this characteristic is advantageous because it tends to reduce pilling when staple made from the filament is blended with cotton.

As known to those familiar with textiles in general and polyester fibers and blends of polyester and cotton in particular, the term “pilling” is used to describe small undesired entanglements of fibers (“pills”) that can result when the surface of a fabric is abraded (including normal wear and tear). In cotton-polyester blends, pilling can be more noticeable because the strength of the polyester tends to preclude pills formed from the polyester fibers from breaking off of the fabric as easily as do pills of cotton fibers. Pilling can be tested using ASTM D3512 (“Standard Test Method for Pilling Resistance and Other Related Surface Changes of Textile Fabrics”) e.g., random tumble testing; or AATCC Test Method 124-2014 (“Smoothness Appearance of Fabrics after Repeated Home Laundering”).

Table 1 lists predictive polyester compositions according to the claimed invention. “TA” again represents terephthalic acid and “EG” again represents ethylene glycol. All of the components are expressed in grams, but the skilled person understands the components that are liquid at room temperature (e.g., EG) can be measured and added by volume (typically milliliters in this context). The density of EG (1.11 g/mL) is used for the conversion. Similarly, for consistency and as a good practice based on the data, the amounts in Table 1 are listed using no more than four significant figures.

As the skilled person is further well aware, the reaction between the acid and the glycol is a condensation reaction. The loss of water means that the total of raw materials will always exceed the resulting amount of polyester.

As Table 1 indicates, representative starting materials can include appropriate catalysts and at least one optical brightener (fluorescent whitening agent). Optical brighteners are generally well understood in the art, and function by absorbing UV radiation (e.g., in the region from 360 to 380 nanometers) and re-emitting longer-wavelength, visible blue-violet light in the visible portion of the spectrum. Such compositions can be selected by the skilled person without undue experimentation, and provided that the selected brightener does not undesirably affect the desired properties of the finished copolymer, fiber, or fabrics. The starting materials can also include small amounts of antimony oxide (0.35 g), 0.02 g of 10% phosphoric acid, and tetramethyl ammonium hydroxide (0.160 g of a 5% solution in water).

TABLE 1
Production of 1000 gram batches of polyester copolymer:

| Component | Units | 1 (Control) | 2 | 3 | 4 | 5 | 6 | 7 |
|---|---|---|---|---|---|---|---|---|
| TA (166 g/mole) | Grams | 863 | 757 | 729 | 702 | 757 | 729 | 702 |
| EG (62 g/mole) | Grams | 322 | 268 | 267 | 265 | 264 | 262 | 262 |
| Antimony Oxide | Grams | 0.30 | 0.3 | 0.3 | 0.3 | 0.3 | 0.3 | 0.3 |
| Cobalt Acetate | Grams | 0.09 | 0.09 | 0.09 | 0.09 | 0.09 | 0.09 | 0.09 |
| Titanium Oxide | Grams | 2.00 | 2.00 | 2.00 | 2.00 | 2.00 | 2.00 | 2.00 |
| Brightener | Grams | 0.20 | 0.20 | 0.20 | 0.20 | 0.20 | 0.20 | 0.20 |
| PEG (400 g/mole) | Grams | 0.00 | 35.00 | 36.00 | 37.00 | 38.00 | 39.00 | 39.00 |
| Sebacic Acid (202 | Grams | 0.00 | 40.00 | 50.00 | 60.00 | 40.00 | 50.00 | 60.00 |
| g/mole) | | | | | | | | |
| Pentaeryrthritol | Grams | 0.00 | 0.5 | 0.5 | 0.5 | 0.8 | 0.8 | 0.8 |
| Total of Raw | Grams | 1185 | 1103 | 1085 | 1067 | 1102 | 1083 | 1066 |
| Materials | | | | | | | | |

Fabrics formed from the compositions in Table 1 can be dyed with disperse dyes in the following generally conventional manner. The fabric to be dyed is placed in an aqueous solution that optionally includes desired auxiliaries (e.g., leveling agents and salt) and allowed to equilibrate as the temperature is raised from room temperature to the dyeing temperature (e.g., above about 150° F.; 66 ° C.), but below boiling) over the course of about 25 minutes. The temperature is then maintained generally constant while the dye is added (in a liquor ratio of about 10:1) over a period of about 15 minutes, after which the temperature is raised to about 195° F. (90° C.) for about 30 minutes to allow the dye to migrate. The temperature is then lowered over an interval of about 10 minutes to about 158° F. (70° C.) and maintained there for about 35 minutes to allow the dye to fix.

The dyed fabric is then rinsed for about 10 minutes at about 122° F. (50° C.), and potentially rinsed more than once depending upon the overall circumstances. The fabric is then neutralized for about 10 minutes at about 160° F. (71° C.), typically with weak acetic acid (e.g., no more than 1%). The fabric can then be soaped for 10 minutes for one or two cycles at about 200° F. (93° C.), depending upon the hardness of the water and the shade of the intended color.

The fabric is then rinsed with hot water (about 160° F.; 71° C.) and then cold water, each for about 10 minutes. If desired or necessary (e.g., depending upon the dye shade or other factors) the fabric can be treated with fixatives (e.g., polymeric quaternary ammonium compounds are exemplary) and softeners.

Although the invention is not limited by any particular theory, it can be hypothesized that the sebacic acid provides the dye receptivity, the pentaerythritol provides the pill resistance, and the polyethylene glycol provides the elasticity to spin the melt into filament.

Accordingly, it will be understood that in one aspect the invention is the composition: polyester, sebacic acid, pentaerythritol, polyethylene glycol, or low amounts of diethylene glycol. In turn, the composition can be understood as a polymerized melt, as a polyester copolymer filament made from the melt, or as a textured filament made from the composition.

Texturing is well understood in the art and will not be otherwise described in detail, other than to point out that to date, the composition of the invention produces filament that can be textured using conventional steps (e.g., heat setting while in a twisted position).

The composition aspects of the invention also include the manufacture of staple fibers cut from the filament (typically from a textured filament), yarns, particularly blends of cotton and the polyester copolymer of the invention, dyed yarns, fabrics, dyed fabrics, and garments.

It will further be understood that the dying step can be carried out on the blended cotton and polyester copolymer yarn, on a fabric formed from the blended yard, or even on a garment formed from the blended yarn.

In the method context, the invention includes the steps of polymerizing a charge of terephthalic acid, ethylene glycol, sebacic acid in an amount of between about 4 and 6 percent sebacic acid, between about 500 and 800 ppm pentaerythritol, and between about 3.5 and 3.9 percent polyethylene glycol to a copolymer melt with less than 2 percent DEG, at an intrinsic viscosity of between about 0.640 and 0.690 dl/g and at a temperature of between about 268° C. and 271° C., with the proportional amounts being based on the amount of polymerized copolymer. The melt is spun into filament in an otherwise conventional process.

The filament produced by the method can be textured and cut into staple fiber, spun into a blended yarn with cotton (typically with cotton in the range of 5.95% by weight) and dyed as yarn. Alternatively, the blended yarn can be woven or knitted into fabric and then dyed and then formed into a garment. In some circumstances, the dyeing step will be carried out on the garment, but dyeing the yarn is probably most common.

Those skilled in the art will also appreciate, however, that the filament can be used as a yarn (“filament yarn”); i.e., without being cut into staple or without being blended with another fiber (e.g., cotton). Such filament yarns are particularly advantageous in the active wear industry. In particular, filament yarn according to the invention provides the opportunity to use spandex that can be dyed at the inventive dyeing temperatures (about 205° F.) while maintaining all of the desired spandex properties. As set forth in the background, variations of spandex that can be dyed at high temperature are available, but at higher cost, and without any corresponding stretch or recovery advantages for active wear purposes.

Because poly-cotton blends are manufactured, sold, and used in a variety of proportions, a potentially wide range (e.g., 5-95% cotton) is possible. Nevertheless, it will be understood that although the invention certainly offers advantages for high cotton blends, the invention provide particular advantages for poly-cotton blends with (e.g.) between about 40% and 60% cotton by weight.

As noted previously, with respect to the composition, in the method steps, the best results are expected with between about 4 and 6 percent sebacic acid, between about 500 and 800 ppm pentaerythritol, and between about 3.5 and 3.9 percent polyethylene glycol, taken to a copolymer melt with less than 2 percent DEG, at an intrinsic viscosity of between about 0.640 and 0.690 dl/g and at a temperature of between about 268° C. and 271° C., with the proportional amounts being based on the amount of polymerized copolymer.

In another aspect, the invention can be considered as the method of dyeing a blended yard formed from cotton and textured polyester staple that starts with the composition described herein. Thus, the dyeing step (disperse dye for polyester) is carried out on a yarn that includes between about 4 and 6 percent sebacic acid, between about 500 and 800 ppm pentaerythritol, and between about 3.5 and 3.9 percent polyethylene glycol, with less than 2 percent DEG, with the proportional amounts being based on the amount of polymerized copolymer, and the method of making the filament.

In another aspect, the invention is the blended yarn itself containing about 5.95% by weight cotton, more typically 40-60% cotton, with the textured polyester copolymer staple as the remainder. The textured polyester copolymer has the composition described with respect to the other embodiments. For the sake of completeness these are between about 4 and 6 percent sebacic acid, between about 500 and 800 ppm pentaerythritol, and between about 3.5 and 3.9 percent polyethylene glycol, with less than 2 percent DEG, with the proportional amounts being based on the amount of polymerized copolymer.

As with the other embodiments, the yarn can be dyed, and formed into fabric and garments with the dyeing being carried out on the blend as opposed to the conventional steps of dyeing cotton separately from polyester.

Thus, using the invention, a blended fabric can be successfully dyed several different ways, depending upon the desired final appearance. The cotton alone can be dyed (reactive dye) or the polyester can be dyed alone (disperse dye). Alternatively, if two dyes are preferred, the invention allows both dyestuffs to be maintained in a single vessel and the fabric dyed in successive steps with both a disperse dye (first) and a reactive dye (second) in that vessel. The successive steps eliminate the conventional rinsing or scouring step between a disperse dyeing step for the polyester and a direct dyeing step for the cotton. In turn, the invention provides the advantages of less water used and less effluent produced.

On a production or continuous scale, the invention is expected to be formed and used in steps with which the skilled person is quite familiar. Thus, as a predictive example, the terephthalic acid and ethylene glycol are mixed into a paste (or slurry) at a mole ratio of between about 1:1 and 1.2:1 (TA to EG). The paste is then transferred to a primary esterifier (“PE”) typically maintained at above-atmospheric pressure and temperatures above 250° C. (typically 260-280° C.). The composition forms the esterified monomer (usually representing about 90 percent esterification). This product is then transferred to a secondary esterifier, at which point the pentaerythritol and sebacic acid can be added. Pressures in the secondary esterifier are lower than the primary esterifier, but temperatures are slightly higher; e.g., 270·275° C., and esterification reaches (for example) about 94%.

The esterified composition is then transferred to the low polymerizer, and if desired the pentaerythritol and sebacic acid alternately can be added between the secondary esterifier and the low polymerizer. The low polymerizer operates at a temperature of about 275-280° C., and under a vacuum to remove the water vapor (the polymerization is a condensation reaction) and the monomers reach a degree of polymerization of about 75-100. The composition is then transferred to a high polymerizer where polymerization reaches much higher numbers, typically on the order of 20,000 units.

The high polymerizer typically runs at temperatures of about 270°-310° C. for standard PET polymers with 285°-290° C. being particularly representative.

Conventional copolymers that contain polyethylene glycol normally would be run at temperatures lower in this range; e.g., about 280° C. In the invention, however, the temperature can be maintained higher (e.g., 285°-290° C.) within the standard range but the intrinsic viscosity is allowed to reach between about 0.58 dl/g and 0.82 dl/g, with about 0.75 dl/g being favored in many circumstances.

Intrinsic viscosity is typically measured in a capillary viscometer using a sample of the polymer dissolved in an appropriate solvent. As an alternative, instruments are available that can measure the intrinsic viscosity directly and without the step of dissolving the polymer in a solvent. The intrinsic viscosities described herein can be measured or confirmed using, for example ASTM D5225 (“Standard Test Method for Measuring Solution Viscosity of Polymers with a Differential Viscometer”) or any test or instrument that gives the same results within an acceptable tolerance or margin of error.

With respect to the invention (and in many cases in general) color fastness represents the resistance of a dyed color to fading or bleeding under various types of influences on the yarn, fabric, or garment. Exposure to water, light, rubbing, washing, and perspiration are typical. Color fastness testing seeks to identify the properties of the material in a manner that is helpful and reproducible.

In a typical test, (AATCC Test Method 61·2013; Colorfastness to Laundering: Accelerated) the fabric color loss and surface changes resulting from detergent solution and abrasive action of five typical hand or home launderings, with or without chlorine, are roughly approximated by one 45 minute test. Samples are exposed to conditions of temperature, detergent solution, bleaching and abrasive action that are expected to produce a color change representative of five hand or home launderings. Standard tests have also been developed by the Society of Dyers and Colorists (SDC; www.sdc.org.uk; accessed Jul. 24, 2015) and the International Organization for Standardization (ISO; www.iso.org; accessed Jul. 24, 2015).

Light fastness (i.e., color fastness under exposure to light) can also be carried out using a high energy xenon fadometers under defined conditions of radiation intensity cycle time (light and dark) and temperature. AATCC Test Method 169-2009, “Weather Resistance of Textiles: Xenon Lamp Exposure,” is an appropriate test.

The resulting color differences can be evaluated using standardized gray scale and gray scale testing methods (e.g., ASTM D2616-12; “Standard Test Method for Evaluation of Visual Color Difference with a Gray Scale”).

Random tumble pilling (“RTP”) and home laundering (“HL”) tests can be carried out using ASTM RTP and ASTM D3512 HL (http://www.astm.org/Standards/D3512.htm; accessed Mar. 3, 2016). The tests are available on a subscription basis, but generally consist of a standardized rubbing action applied between a sample fabric and a standard fabric. A particular number of rubs are carried out, following which the samples are examined to determine the number of pills created. The fabrics are placed on rectangular blocks to carry out the rubbing motion.

As noted earlier, the blended yarns or fabrics can be dyed using a one-vessel two-step dyeing process that significantly saves both resources and energy. In such a successive step dyeing process, water and disperse dye (for the polyester) and reactive dye (for the cotton) are all added together to form the dye solution. In the first step, a weak acid (typically acetic) is added to bring the pH to between about 5.5 and 6.5. The mixture is then heated to a temperature of about 205° F.; i.e., a temperature at which the inventive polyester will dye, but standard polyester will not.

In a second step in the same vessel—which is not possible with standard polyester—salt and caustic (i.e., a base, typically sodium hydroxide, NaOH) are added to the same vessel to activate the reactive cotton dye and bring the pH to the basic side (e.g. about 8).

This one-vessel two-step process avoids the need to empty the dye vessel (“pot”) after the polyester dying step and to refill it for the cotton dying step. At a minimum this provides a significant time savings which becomes cumulatively advantageous for repeated dyeing steps. Secondly, because the temperature of the bath can be the same for both the cotton and polyester dyeing steps, less heating is required, as is the time required for re-heating. The result is a fully dyed blended fabric from the single dye bath.

In the specification there has been set forth a preferred embodiment of the invention, and although specific terms have been employed, they are used in a generic and descriptive sense only and not for purposes of limitation, the scope of the invention being defined in the claims.

1. A copolymer composition with advantages for textile fibers, and consisting essentially of a melt of:
polyester precursors selected from the group consisting of terephthalic acid, dimethyl terephthalate, and ethylene glycol;
between about 4 and 6 percent sebacic acid based on the amount of copolymer;
between about 500 and 800 parts per million (ppm) of pentaerythritol based on the amount of copolymer; and
between about 3.5 and 3.9 percent polyethylene glycol based on the amount of copolymer;
diethylene glycol (DEG) in an amount of less than 2 percent based upon the amount of copolymer; and
said melt being maintained at a temperature of between about 268° C. and 271° C., and at an intrinsic viscosity of between about 0.640 and 0.690 dl/g.

2. A copolymer composition according to claim 1 comprising:
about 4 percent sebacic acid based on the amount of copolymer;
about 500 parts per million (ppm) of pentaerythritol based on the amount of copolymer; and
about 3.5 percent polyethylene glycol based on the amount of copolymer.

3. A copolymer composition according to claim 1 comprising:
about 5 percent sebacic acid based on the amount of copolymer;
about 500 parts per million (ppm) of pentaerythritol based on the amount of copolymer; and
about 3.6 percent polyethylene glycol based on the amount of copolymer.

4. A copolymer composition according to claim 1 comprising:
about 6 percent sebacic acid based on the amount of copolymer;
about 800 parts per million (ppm) of pentaerythritol based on the amount of copolymer; and
about 3.7 percent polyethylene glycol based on the amount of copolymer;

5. A copolymer composition according to claim 1 comprising:
about 4 percent sebacic acid based on the amount of copolymer;
about 800 parts per million (ppm) of pentaerythritol based on the amount of copolymer; and
about 3.8 percent polyethylene glycol based on the amount of copolymer.

6. A copolymer composition according to claim 1 comprising:
about 5 percent sebacic acid based on the amount of copolymer;
about 800 parts per million (ppm) of pentaerythritol based on the amount of copolymer; and
about 3.9 percent polyethylene glycol based on the amount of copolymer.

7. A copolymer composition according to claim 1 comprising:
about 6 percent sebacic acid based on the amount of copolymer;
about 800 parts per million (ppm) of pentaerythritol based on the amount of copolymer; and
about 3.9 percent polyethylene glycol based on the amount of copolymer.

8. A polyester copolymer filament consisting essentially of between about 4 and 6 percent sebacic acid;
between about 500 and 800 ppm pentaerythritol;
between about 3.5 and 3.9 percent polyethylene glycol;
with less than 2 percent DEG,
and with the proportional amounts being based on the amount of polymerized copolymer.

9. A textured polyester copolymer filament yarn according to claim 8.

10. A textured staple fiber formed from the polyester copolymer filament of claim 8.

11. A blended yarn formed from cotton and the textured polyester copolymer staple fiber of claim 10.

12. A blended yarn according to claim 11 in which the cotton is present in the range of between about 40 and 60% by weight.

13. A dyed fabric formed from the blended yarn of claim 13.

14. A method of spinning a polyester copolymer filament comprising the steps of:
polymerizing terephthalic acid, ethylene glycol, between about 4 and 6 percent sebacic acid, between about 500 and 800 ppm pentaerythritol, and between about 3.5 and 3.9 percent polyethylene glycol to a copolymer melt;
with less than 2 percent DEG;
at an intrinsic viscosity of between about 0.640 and 0.690 dl/g;
and at a temperature of between about 268° C. and 271° C.;
with the proportional amounts being based on the amount of polymerized copolymer.

15. A method according to claim 14 further comprising the steps of extruding and quenching the copolymer polyester filament.

16. A method according to claim 15 further comprising the step of texturing the quenched copolymer polyester filament.

17. A method according to claim 16 further comprising cutting the textured copolymer polyester filament into staple fiber.

18. A method according to claim 17 further comprising blending the cut staple polyester copolymer with cotton fibers into a blended yarn.

19. A method according to claim 18 further comprising
forming a fabric from the blended yarn; and
thereafter dying the blended fabric with a dye selected from the group consisting of disperse dyes, reactive dyes, and successive steps of disperse and reactive dyes.
